(19) United States
(12) Patent Application Publication
(10) Pub. No.: US 2010/0021158 A1
(43) Pub. Date: Jan. 28, 2010

(54) OPTICAL COMMUNICATIONS SYSTEM WITHOUT USING A SPECIAL-PURPOSE EVALUATION SIGNAL

(76) Inventors: YOSHINORI KANNO, Tokyo (JP); Ken Shiraishi, Tokyo (JP); Sadaichiro Ogushi, Tokyo (JP)

Correspondence Address: Mr. Jackson Chen, 6535 N. STATE HWY 161, IRVING, TX, 75039, US

(21) Appl. No.: 12/507,431

(22) Filed: Jul. 22, 2009

(30) Foreign Application Priority Data
Jul. 23, 2008 (JP) 2008-189699

(51) Int. Cl. H04B 10/08

(52) U.S. Cl. 398/27

(57) ABSTRACT

A subscriber terminating unit includes an error count counting portion counting an error count in a predetermined time range based on the number of corrections by an error correction function and an error count transmitting portion transmitting the error count to an office terminating unit. The office terminating unit includes an error count receiving portion receiving the error count from the subscriber terminating unit as a received error count and a correction method determining portion determining, based on the received error count, an error correction method or an error correction disuse which is used in the subscriber terminating unit.

This application is based upon and claims the benefit of priority from Japanese patent application No. 2008-189699, filed on Jul. 23, 2008, the disclosure of which is incorporated herein in its entirety by reference.

### BACKGROUND OF THE INVENTION

1. Technical Field

This invention relates to an optical communications system such as a PON (Passive Optical Network) system, and more particularly, to an office terminating unit (OLT; Optical Line Terminal) and a subscriber terminating unit (ONU; Optical Network Unit) for use in the optical communications system.

2. Background Art

FIG. 1 shows structure of a general PON system. As shown in FIG. 1, the general PON system comprises an optical line terminal (OLT) 901, an optical transmission path 902, an optical coupler 903, and first through N-th optical network units (ONUs) 904-1, . . . , 904-N where N represents a positive integer which is not less than two. The first through the N-th optical network units (ONUs) 904-1 to 904-N are connected to the optical line terminal (OLT) 901 through the optical transmission path 902 and the optical coupler 903. In each of the first through the N-th optical network units (ONUs) 904-1 to 904-N, an error correction function is set to any one of ON and OFF.

In the example being illustrated in FIG. 1, the first optical network unit (ONU) 904-1 is set to the error correction of ON while the N-th optical network unit (ONU) 904-N is set to the error correction of OFF. In this event, as a format of an up-link signal of shown in FIG. 2, an output of the first optical network unit (ONU) 904-1 is added to a fixed overhead of a parity for an error correction.

However, in the above-mentioned general PON system illustrated in FIG. 1, the overhead of parity of the error correction is constantly added independent of a line state and it results in fixedly degradation of a band.

Various related arts of the present invention are already known. By way of example, Japanese Unexamined Patent Application Publication (Translation of PCT Application) No. 2006-510311 or JP-A 2006-510311 (which will be also called Patent Document 1), which corresponds to U. S. Patent Application Publication No. US 2008/0260378, discloses a method of managing forward error correction (FEC) in an Ethernet passive optical network (PON) including at least one optical network unit (ONU). The method disclosed in Patent Document 1 comprises the steps of monitoring, in the OLT, communications quality from the at least one ONU, thereby determining a figure of merit of the communications of each ONU, of carrying out communications with non-FEC data to the ONU where the figure of merit is sufficient, and of carrying out communications with FEC data to the ONU where the figure of merit is insufficient.

In the above-mentioned Patent Document 1, in the similar manner of structure illustrated in FIG. 1, the respective optical network units (ONUs) have predetermined fixed error correction functions each of which is set to any one of ON and OFF. Patent Document 1 does not keep in mind optimization of a length of the overhead of the parity for the error correction by changing an error correction method.

Japanese Unexamined Patent Application Publication of Tokkai No. 2007-36712 or JP-A 2007-36712 (which will be also called Patent Document 2) discloses a communications method comprising the steps of measuring, in the OLT, a Round Trip Time (RTT) upon establishing a logical link, of selecting, in the OLT, an FEC redundancy in accordance with the RTT, and of carrying out communications to the ONU based on a selected FEC redundancy.

The communications method disclosed in Patent Document 2 selects the FEC redundancy in accordance with a distance between the ONU and the OLT due to the Round Trip Time (RTT). However, Patent Document 2 comprehensively does not keep in mind various environmental conditions in an optical transmission path such as the number of branches of the optical transmission path, the luminous intensity of transmission light, strength of a received signal, the presence or absence of a relay station, performance of the relay station, and so on.

Japanese Unexamined Patent Application Publication of Tokkai No. 2007-104571 or JP-A 2007-104571 (which will be also called Patent Document 3) discloses a method comprising the steps of requesting, in the ONU, to the OLT the transmission of evaluation data as material of judging an error correction ability, of transmitting from the OLT to the evaluation data, and of measuring, in the ONU, an error rate based on the evaluation data. In Patent Document 3, the method further comprises the steps of determining, in the ONU, degree of error correction coding on the basis of the measured error rate and of transmitting from the ONU an uplink data with redundancy data of the error correction coding added.

In Patent Document 3, it is necessary to transmit, from the OLT, a special-purpose evaluation signal for measurement of the error rate. Accordingly, it results in consuming an excess band for the measurement. In addition, it is necessary for Patent Document 3 to provide a processing portion dealing with the special-purpose evaluation signal.

### SUMMARY

An exemplary object of the invention is to provide a communications method that it is unnecessary to use a special-purpose evaluation signal.

A communications method according to an exemplary aspect of the invention is for an optical communications system including an office terminating unit and a plurality of subscriber terminating units each of which is connected to the office terminating unit via an optical transmission path. The communications method includes counting, in each of the plurality of subscriber terminating units, an error count in a predetermined time range based on the number of corrections by an error correction function, transmitting the error count from each of the plurality of subscriber terminating units to the office terminating unit, receiving, in the office terminating unit, the error count as a received error count, and determining, in the office terminal unit, based on the received error count, an error correction method or an error correction disuse which is used in each of the plurality of subscriber terminating units as a determined error correction method or a determined error correction disuse.

### BRIEF DESCRIPTION OF THE DRAWINGS

The above feature and advantages of the present invention will be more apparent from the following description of certain exemplary embodiments taken in conjunction with the accompanying drawing, in which:

FIG. 1 is a block diagram showing structure of a general PON system;

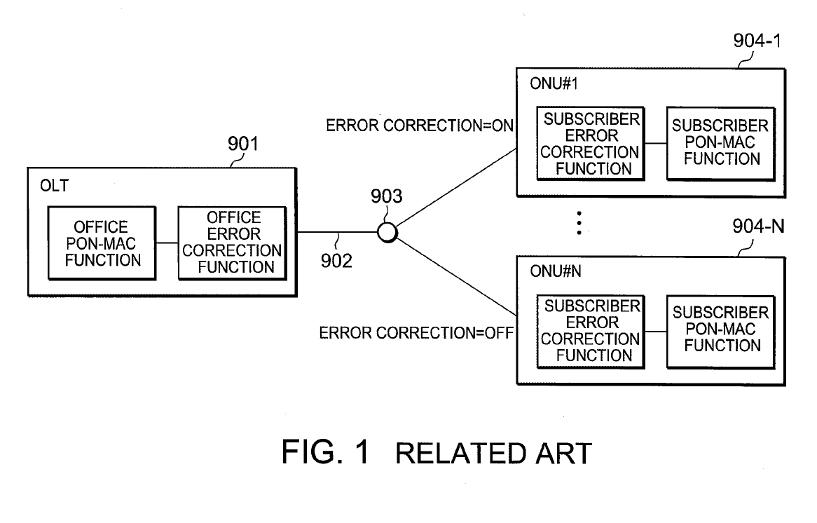

FIG. 2 is a view showing a format of data in an up-link direction in the general PON system illustrated in FIG. 1;

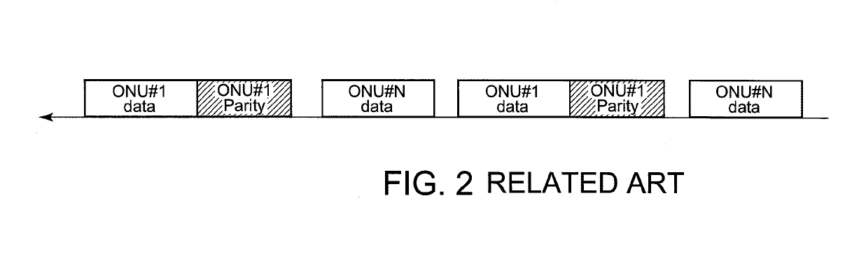

FIG. 3 is a block diagram showing an overview of a PON system according to a first exemplary embodiment of the present invention;

FIG. 4 is a block diagram schematically showing structure of a PON system according to a second exemplary embodiment of the present invention;

FIG. 5 is a view showing a format of data in an up-link direction in the PON system illustrated in FIG. 4;

FIG. 6 is a sequence chart showing an MPCP (Multipoint Control Protocol) sequence for use in the PON system illustrated in FIG. 4;

FIG. 7 is a flow chart for use in describing operation of the PON system illustrated in FIG. 4;

FIG. 8 is a block diagram showing structure of a PON system according to a third exemplary embodiment of the present invention in detail; and

FIG. 9 is a view showing a format of data in a down-link direction in the PON system illustrated in FIG. 8.

### DETAILED DESCRIPTION OF EXEMPLARY EMBODIMENTS:

A gigabit Ethernet-passive optical network (G-EPON) system is a system which is constructed by equipping Ethernet (registered trademark) into a passive optical network (PON) system. The description will be made as regards exemplary embodiments of the present invention which are applicable to the G-EPON system.

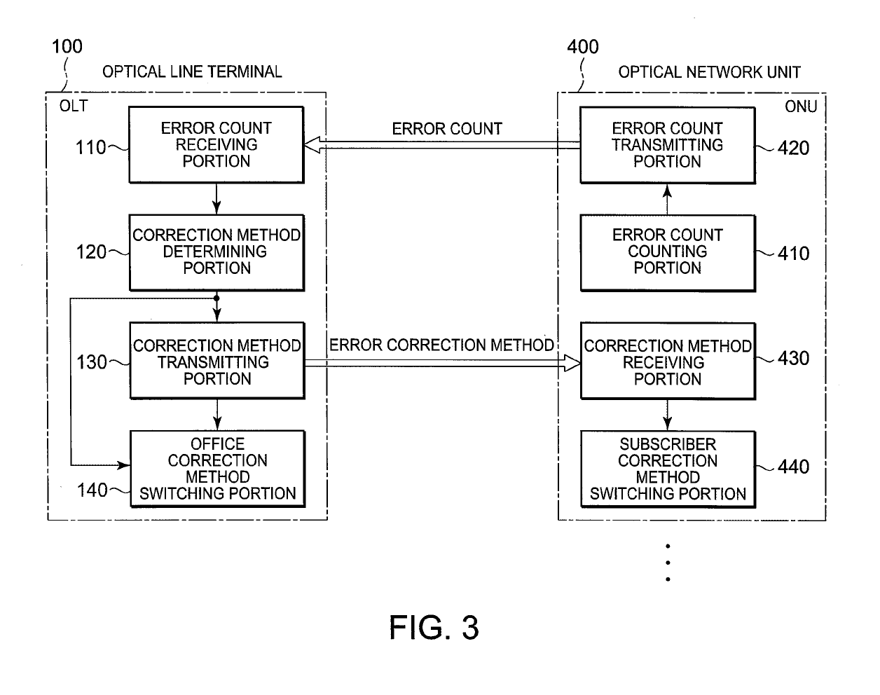

Referring to FIG. 3, the description will proceed to a passive optical network (PON) system according to a first exemplary embodiment of the present invention. The PON system is one of optical communications systems. The PON system comprises an optical line terminal (OLT) 100 and a plurality of optical network units (ONUs) 400. In FIG. 3, a specific one of the optical network units (ONUs) 400 alone is drown. The optical line terminal (OLT) 100 serves as an office terminating unit while each optical network unit (ONU) 400 serves as a subscriber terminating unit. The optical line terminal 100 is connected to the optical network units 400 through an optical transmission path (not shown).

The optical network unit (ONU) 400 comprises an error count counting portion 410, an error count transmitting portion 420, a correction method receiving portion 430, and a subscriber correction method switching portion 440. The optical line terminal (OLT) 100 comprises an error count receiving portion 110, a correction method determining portion 120, a correction method transmitting portion 130, and an office correction method switching portion 140.

In the specific optical network unit (ONU) 400, the error count counting portion 410 counts, about transmission data from the optical line terminal (OLT) 100, an error count in a predetermined time range based on the number of corrections by an error correction function. The error count transmitting portion 420 transmits the error count to the optical line terminal (OLT) 100.

In the optical line terminal (OLT) 100, the error count receiving portion 110 receives the error count from the specific optical network unit (ONU) 400 as a received error count. The correction method determining portion 120 determines, based on the received error count, an error correction method or an error correction disuse which is used in the specific optical network unit (ONU) 400. The correction method determining portion 120 produces a determined error correction method or a determined error correction disuse. The correction method transmitting portion 130 transmits the determined error correction method or the determined error correction disuse to the specific optical network unit (ONU) 400 which is a transmission source for transmitting the error count.

In the specific optical network unit (ONU) 400, the correction method receiving portion 430 receives the determined error correction method or the determined error correction disuse from the optical line terminal (OLT) 100 as a received error correction method or a received error correction disuse. The subscriber correction method switching portion 440 carries out communications at the received error correction method.

In the optical line terminal (OLT) 100, when the determined error correction method or the determined error correction disuse to be used is determined by the correction method determined portion 120, the office correction method switching portion 140 carries out communications using the determined error correction method.

In the manner which is described above, inasmuch as a measured value of the error count is used in the first exemplary embodiment of the present invention, it is possible to automatically optimize the error correction method in consideration of various types of environmental conditions in the optical transmission path without using a special-purpose evaluation signal. Accordingly, it is possible to optimize a length of an overhead in a parity for error correction and it is therefore possible to effectively make full use of a band.

Now, the description will proceed to the G-EPON system which is used in the exemplary embodiments of the present invention.

The G-EPON system is a time division multiplexing (TDM) system which carries out data transfer by assigning a band in an up-link direction with each optical network unit (ONU) on a temporal axis from the optical line terminal (OLT). For example, the general G-EPON system is an optical communications system which has a transmission rate of 1.25 Gbps in the up-link direction and of 1.25 Gbps in a down-link direction and which has an error correction method of Reed-Solomon of RS (255, 239).

In IEEE (Institute of Electrical and Electronics Engineers) 802.3av, there are two systems: one has a transmission rate of 1.25 Gbps in the up-link direction and of 10.3125 Gbps in the down-link direction and another has a transmission rate of 10.3125 Gbps in the up-link direction and of 10.3125 Gbps in the down-link direction with the error correction method unified to one.

The G-EPON system according to the exemplary embodiments of the present invention is a system which effectively makes full use of the band by setting the error correction method for each optical network unit (ONU) in the PON system.

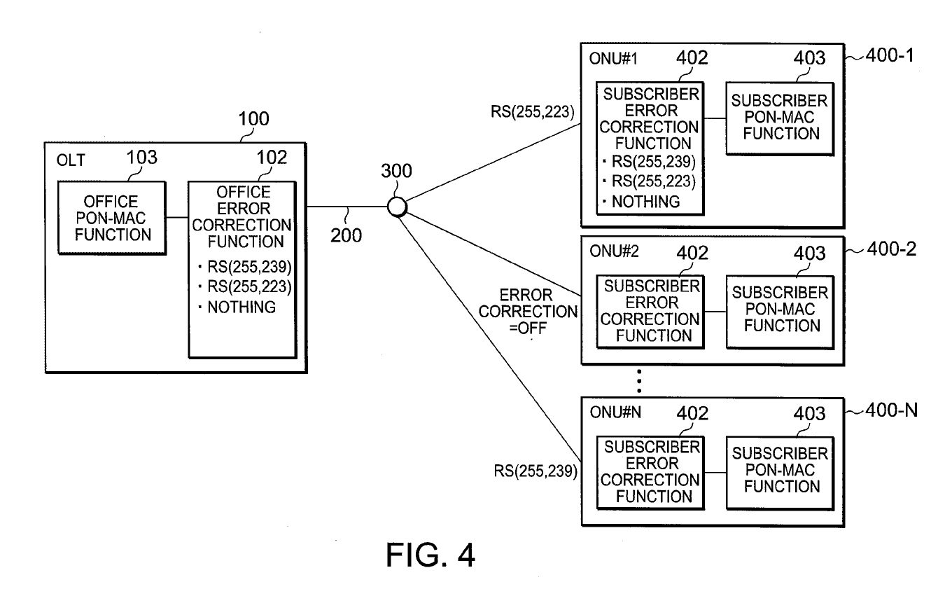

Referring now to FIG. 4, the description will proceed to a PON system according to a second exemplary embodiment of the present invention. FIG. 4 is a block diagram of the PON system to which an error correction automatic discrimination system is applied.

The illustrated G-EPON system comprises the optical line terminal (OLT) 100 and first through N-th optical network units (ONUs) 400-1, 400-2, . . . , and 400-N each of which is connected to the optical line terminal (OLT) 100 via the optical transmission path depicted at 200 such as an optical fiber or the like and an optical coupler (a branch arrangement) 300, where N represents a positive integer which is not less than two.

The optical line terminal (OLT) comprises an office error correction function 102 and an office PON-MAC (media access control) function 103. Each of the first through the N-th optical network units (ONUs) 400-1 to 400-N comprises a subscriber error correction function 402 and a subscriber PON-MAC function 403.

In the G-EPON system according to the second exemplary embodiment of the present invention, each of the first through the N-th optical network units (ONUs) 400-1 to 400-N observes a line state thereof by date transmission as a bit error rate and the optical line terminal (OLT) 100 selects the error correction method for each optical network units (ONUs) 400-1 to 400-N.

In the example being illustrated, FIG. 4 shows a case where the first optical network unit (ONU) 400-1 has the error correction method of RS(255, 223), the second optical network unit (ONU) 400-2 has the error correction method of disuse of an error correction function, and the N-th optical network unit (ONU) 400-N has the error correction method of RS(255, 239).

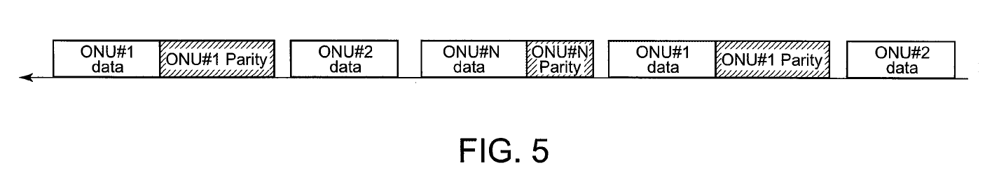

In the case of FIG. 4, overhead in output data of each optical network unit (ONU) is delivered with the line state matched in the band of the up-link direction as shown in FIG. 5. Accordingly, it is unnecessary to make data for the error correction longer and it is therefore possible to improve transmission efficiency.

In addition, a selection method of the error correction method in each optical network unit (ONU) can be realized by calculating a reception timing by an MPCP (Multipoint Control Protocol) function portion (not shown) and by selecting the error correction method for each temporal axis.

Now, the description will be made as regards operation of the G-EPON system according to the second exemplary embodiment of the present invention.

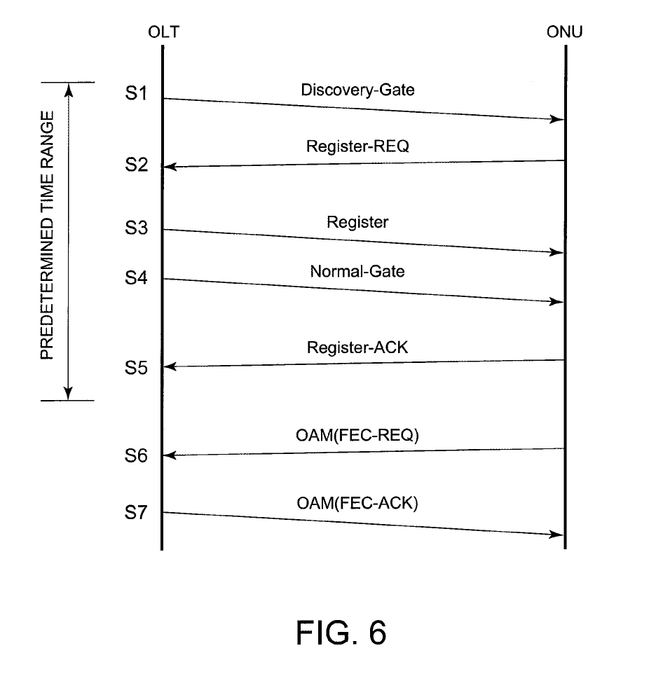

Referring first to FIG. 6, the description will proceed to a sequence of a link establishment of the MPCP, of a detection of an error rate, and of a notification thereof. In the description as follows, the error correction method is exemplified.

The sequence of steps S1 through S5 in FIG. 6 is similar to a procedure of the link establishment for the MPCP in the general G-EPON system. In the second exemplary embodiment of the present invention, the sequence of the steps S1 through S5 carries out communications between the optical line terminal (OLT) and the optical network unit (ONU) using the error correction method of RS(255, 223).

In the sequence of the steps S1 through S5, the optical network unit (ONU) carries out error correction of data received from the optical line terminal (OLT) to calculate the error rate. The error rate is an error count corrected by the error correction function in a predetermined time range between a sequence starting time instant of the logical link establishment by the MPCP and a completed time instant at which the logical link is established, namely, between the step S1 and the step S5.

After the logical link is established in the step S5, the optical network unit (ONU) produces an OAM (FEC-REQ) signal to deliver the error rate to the optical line terminal (OLT) at a step S6. The step S6 is followed by a step S7 at which the optical line terminal (OLT) produces an OAM(FEC-ACT) signal to deliver, to the optical network unit (ONU), the error correction method which is used in data communications between the optical line terminal (OLT) and the optical network unit (ONU) after the logical link of the MPCP is established.

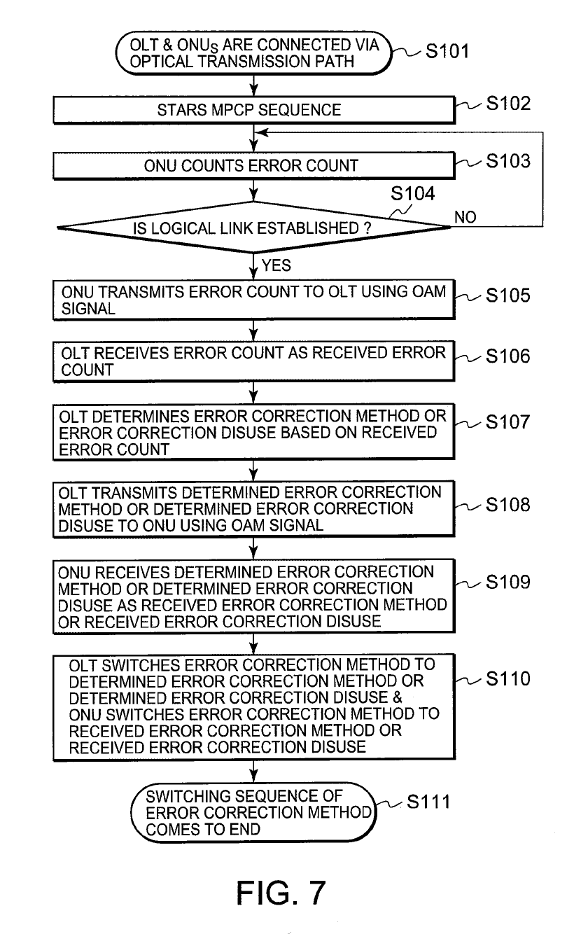

Referring now to FIG. 7 in addition to FIG. 4, a brief description will proceeds to structure and operation of the G-EPON system according to the second exemplary embodiment of the present invention.

As mentioned before, the G-EPON system comprises the optical line terminal (OLT) 100 and the first through the N-th optical network units (ONUs) 400-1 to 400-N each of which is connected to the optical line terminal (OLT) 100 via the optical transmission path 200 such as the optical fiber and the optical coupler (the branch arrangement) 300 (a step S101).

In the example being illustrated in FIG. 4, it is assumed that each of the optical line terminal (OLT) 100 and the first through the N-th optical network units (ONUS) 400-1 to 400-N can select, as the error correction function, one of RS(255, 239), RS(255, 223), and error correction-less.

Between the optical line terminal (OLT) 100 and each of the first through the N-th optical network units (ONUs) 400-1 to 400-N, the logical link is established by the MPCP sequence which adheres to standard for IEEE 802.3ah. In the link establishment by the MPCP sequence for each of the first through the N-th optical network units (ONUs) 400-1 to 400-N, the optical line terminal (OLT) 100 first carries out the link establishment by the MPCP sequence using RS(255, 223) as the error correction method in the above-mentioned steps S1 to S5 in FIG. 6 (a step S102).

Each of the first through the N-th optical network units (ONUs) 400-1 to 400-N carries out, about data received from the optical line terminal (OLT) 100, the error correction using the established RS(255, 223) and counts an error count subjected to the error correction in the predetermined time range between the starting time instant of the MPCP sequence and the completed time instant at when the logical link is established, namely, between a stating time instant of the step S1 and a competed time instant of the step S5 (a step S103).

After the logical link is established (YES in a step S104), an n-th optical network unit (ONU) 400-n, which is connected to the optical line terminal (OLT) 100, transmits the error count to the optical line terminal (OLT) 100 as the OAM(FEC-REC) signal (see, the step S6 in FIG. 6) using an OAM (Operations, Administration, and Maintenance) frame, where n represents a variable between one and N, both inclusive (a step S105).

The optical line terminal (OLT) 100 receives the error count from the n-th optical network unit (ONU) 400-n as a received error count (at a step S106) and determines an error correction method or an error correction disuse based on the received error count (a step S107). The optical line terminal (OLT) 100 transmits the determined error correction method or the determined error correction disuse to the n-th optical network unit (ONU) 400-n as the OAM(REC-ACK) signal (see, the step S7 in FIG. 6) using the OAM frame (at a step S108).

The n-th optical network unit (ONU) 400-n receives the determined error correction method or the determined error correction disuse as a received error correction method or a received error correction disuse (at a step S109).

The optical line terminal (OLT) 100 switches the error correction method to the determined error correction method or the determined error correction disuse while the n-th optical network unit (ONU) 400-n switches the error correction method to the received error correction method or the received error correction disuse (at a step S110).

The sequence for switching the error correction method comes to an end (at a step S111).

Accordingly, in consideration of the error correction method for each optical network unit (ONU), processing of the band assignment and the error correction matched to each optical network unit (ONU) is carried out. With this structure, as shown in FIG. 5, it is possible to optimize the length of the overhead in a parity for the error correction in the up-link direction in the first through the N-th optical network units (ONUs) 400-1 to 400-N and it is therefore possible to improve the transmission efficiency.

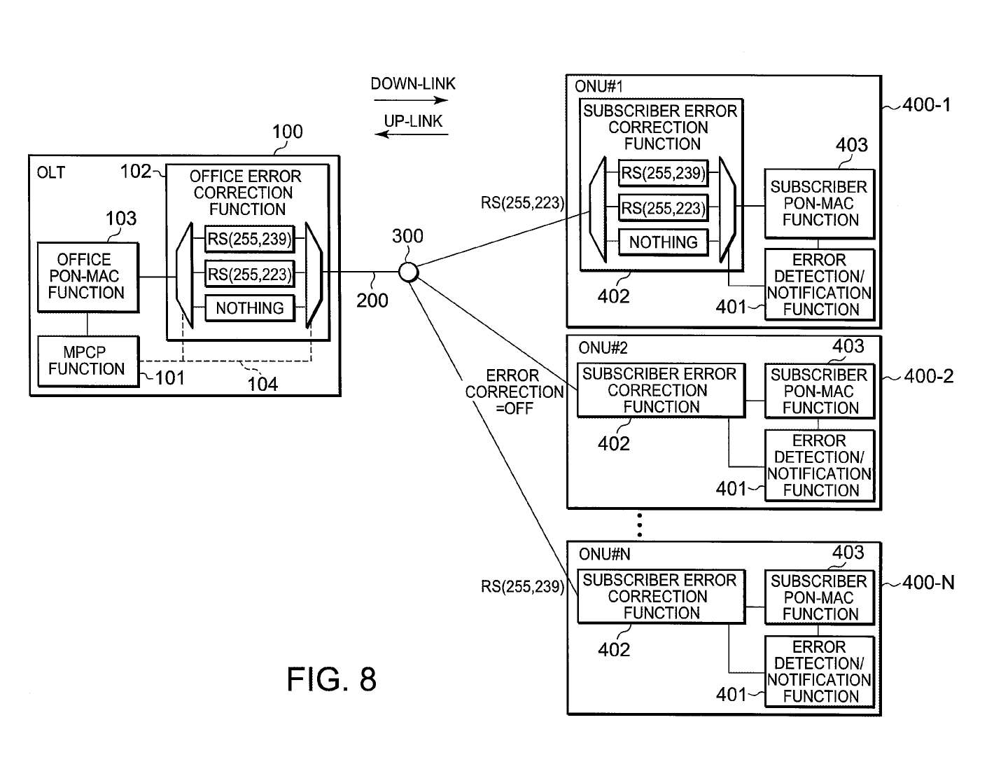

Referring now to FIG. 8, the description will proceed to structure and operation of a G-EPON system according to a third exemplary embodiment of the present invention in detail.

As shown in FIG. 8, the optical line terminal (OLT) 100 comprises an MPCP function 101 for setting a temporal axis of the up-link direction to each optical network unit (ONU) connected thereto, the office error correction function 102, and the office PON-MAC function 103. The office error correction function 102 and the MPCP function 101 are connected to each other via a selection signal line 104 so as to carry out the error correction of data received from the optical network unit (ONU).

The n-th optical network unit 400-n comprises an error detection/notification function 401 for detecting and notifying the error count, the subscriber error correction function 402, and the subscriber PON-MAC function 403.

Each of the office error correction function 102 in the optical line terminal (OLT) 100 and the subscriber error correction function 402 in the optical network unit (ONU) 400 can support a plurality of error correction methods and an error correction disuse. In the example being illustrated, the plurality of error correction methods support RS(255, 239) and RS(255, 223) and it is possible to select any one of their error correction method or the error correction disuse.

Referring now to FIG. 8, the description will proceed to a selection processing of the error correction function in the G-EPON system according to the third exemplary embodiment of the present invention in detail.

On establishing the logical link of the MPCP sequence shown in the steps S1 to S5 of FIG. 6, the optical line terminal (OLT) 100 carries out establishment of the logical link with the first through the N-th optical network units (ONUs) 400-1 to 400-N using the error correction method of RS(255, 223) in the down-link direction. After the logical link is established, by receiving the OAM(FEC-REC) signal from each of the first through the N-th optical network units (ONUs) 400-1 to 400-N, the optical line terminal (OLT) 100 recognizes or distinguishes the error rate in each of the first through the N-th optical network units (ONUs) 400-1 to 400-N and determines an error correction method or an error correction disuse in the up-link direction for each of the first through the N-th optical network units (ONUs) 400-1 to 400-N.

The error rate in each of the first through the N-th optical network units (ONUs) 400-1 to 400-N is counted as the error count (the number of corrections) corrected by the error correction function in the predetermined time range between the starting time instant of the logical link in the MPCP sequence and the completed time instant at which the logical link is completed, namely, between the steps S1 to S5 of FIG. 6.

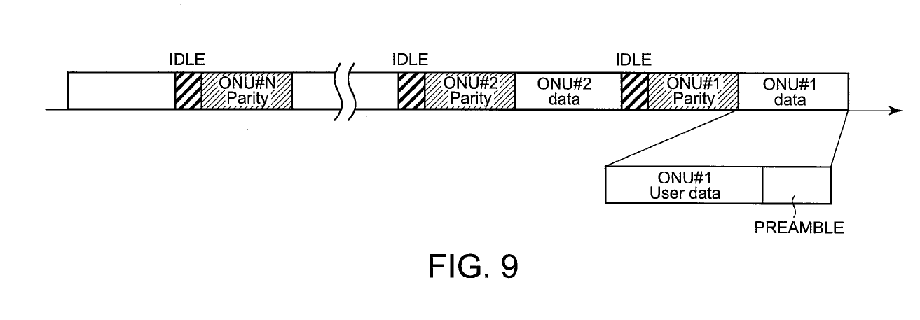

FIG. 9 shows an example of a format of data in the down-link direction. As shown in FIG. 9, the error count corrected by the error correction function is counted in an IDLE portion as well as a data frame portion in the predetermined time range between the steps S1 to S5 of FIG. 6. It is therefore possible to measure the error rate in the predetermined time range which is more and it is possible to improve the accuracy of measurement.

When the optical line terminal (OLT) 100 receives the error rate from the n-th optical network unit (ONU) 400-n using the OAM(FEC-REC) signal, the optical line terminal (OLT) 100 determines, using predetermined thresholds in two levels, an error correction method or an error correction disuse used in communications to the n-th optical network unit (ONU) 400-n which is a transmission source for transmitting the error rate (a correction method determining step or process).

Determination of the error correction method using the predetermined thresholds of two levels is as follows in the example being illustrated in FIG. 8. It will be assumed that the predetermined thresholds of two levels comprise a first threshold level and a second threshold level higher than the first threshold level. When the error rate is lower than the first threshold level, the optical line terminal (OLT) 100 determines the error correction disuse. When the error rate is not lower than the first threshold level and is lower than the second threshold level, the optical line terminal (OLT) 100 determines RS(255, 239) as a relatively weak error correction method. When the error rate is not lower than the second threshold level, the optical line terminal (OLT) 100 determines RS(255, 223) as a relatively strong error correction method.

When the optical line terminal (OLT) 100 determines the error correction method or the error correction disuse about the n-th optical network unit (ONU) 400, the optical line terminal (OLT) 100 transmits the determined error correction method or the error correction disuse using the OAM(FEC-ACK) signal to the n-th optical network unit (ONU) 400-n serving as the transmission source for transmitting the error rate (a correction method transmitting step or process).

When the n-th optical network unit (ONU) 400-n receives the determined error correction method or the determined error correction disuse from the optical line terminal (OLT) 100 using the OAM(FEC-ACK) signal as a received error correction method or a received error correction disuse (a correction method receiving step or process), the n-th optical network unit 400-n carries out communications with the optical line terminal (OLT) 100 using the received error correction method from that time forward (a correction method switching step or process).

The MPCP function 101 in the optical line terminal (OLT) 100 assigns output times for each of the first through the N-th optical network unit (ONUs) 400-1 to 400-N on the temporal axis of the up-link direction. The MPCP function 101 calculates a output timing of data from each of the first through the N-th optical network units (ONUs) 400-1 to 400-N and a delay time interval until the office error correction function 102 due to the optical transmission path 200 to carry out control of the office error correction function 102 using the selection signal line 104.

The office error correction function 102 carries out the error correction of the received data using the determined error correction method for each of the first through the N-th optical network units (ONUs) 400-1 to 400-N based on the calculated timing control. The office error correction function 102 produces error-corrected data which is supplied to the office PON-MAC function 103. With this structure, it is possible to decode, using correct error correction methods, data produced by each of the first through the N-th optical network units (ONUs) 400-1 to 400-N.

In the manner which is described above, according to the above-mentioned exemplary embodiments, the following advantages are obtained.

A first advantage is that it is possible to optimize the length of the overhead in the parity for the error correction and to improve the transmission efficiency. This is because the error correction method is optimized by using the error count corrected by the error correction function in the optical network unit (ONU).

A second advantage is that it is unnecessary to select and receive the error correction method every when the optical line terminal (OLT) receives data in the up-link direction and there is no mistake about selection of the error correction method based on a bit error of the received data. This is because selection of the error correction method in the up-link direction is carried out on establishment of the logical link of the MPCP sequence.

A third advantage is that it has no effect on a transmission characteristic in the up-link direction. This is because there is no mistake about selection of the error correction method and the error correction method does not change every output in the up-link direction because selection of the error correction method in the up-link direction is carried out on establishment of the logical link of the MPCP sequence.

In the manner which is described above, according to the exemplary embodiments of the present invention, it is possible to provide an automatic discrimination function of the error correction method in the PON system.

In addition, inasmuch as the optical line terminal (OLT) carries out, about a signal of the up-link direction as outputs of the optical network units (ONUs), selection of the error correction method on the temporal axis in consideration of the delay time or the like is carried out and decoding is carried out, it is possible to realize the error correction with reliability although the error correction methods are different from each other in the optical network units (ONUs).

The PON system comprises a 1-to-N connection where a lot of optical network units (ONUs) are connected to a single optical line terminal (OLT) and outputs of the respective optical network units (ONUs) in the up-link direction are multiplexed in a time-division fashion. Accordingly, if notification of the error correction method is subjected every data received from the optical network units (ONUs), there is a potential for discrimination to become difficult. However, inasmuch as selection of the error correction method in the up-link direction is carried out on establishing the logical link in the MPCP sequence in the manner described above, it is unnecessary to subject notification of the error correction method every data received from the optical network units (ONUs) and stable communications can be made without mistakes in selection of the error correction method.

In the manner which is described above, according to the exemplary embodiments of the present invention, it is possible to select strength of the error correction function in accordance with quality of a transmission path by carrying out evaluation of the quality of the transmission path using a corrected result of the error correction function or an error count in the respective optical network units (ONUs) on establishing the logical link in the MPCP sequence. Therefore, the exemplary embodiments of the present invention have a characteristic where a band is effectively put to use.

Although the error rate in the received data from the optical line terminal (OLT) on establishing the logical link in the MPCP sequence is used in determination of the error correction method in the up-link direction of the optical network units (ONUs), the IDLE portion in addition to a normal data frame portion is used on calculation of the error rate in the exemplary embodiments of the present invention. It is therefore possible to improve the precision of detection of the error rate.

In addition, by recording, as a program, in a recording medium a processing procedure for realizing the optical line terminal (OLT) and the optical network units (ONUs) in each of the above-mentioned exemplary embodiments, it is possible to realize the above-mentioned respective functions according to the respective exemplary embodiments of the present invention by making a central processing unit (CPU) in a computer configuring the unit carry out processing on the basis of the program supplied from the recoding medium.

In this event, the present invention is also applied in a case where a group of pieces of information including the program is supplied to an output device from the above-mentioned recording medium or an external recording medium via a network.

Specifically, program codes per se read out of the recording medium realize a new function of the present invention, and the recording medium storing the program codes and a signal read out of the recoding medium configure this invention.

The recording medium may comprise, for example, one selected from the group consisting of a flexible disk, a hard disk, an optical disc, a magneto-optical disc, a compact disc read only memory (CD-ROM), a compact disc-recordable (CD-R), a CD-rewritable (CD-RW), a DVD-read only memory (DVD-ROM), a DVD-random access memory (DVD-RAM), a DVD-RW, a DVD+RW, a magnetic tape, a nonvolatile memory card, and a read only memory (ROM).

According to the program relating to the present invention, it is possible to make the optical line terminal (OLT) and the optical network units (ONUs) controlled by the program in question realize the respective functions in the above-mentioned exemplary embodiments of the present invention.

A fourth exemplary embodiment of the invention is an optical communications system including an office terminating unit, a plurality of subscriber terminating units, and an optical transmission path communicatively connecting the office terminating unit with the plurality of subscriber terminating units. Each of the subscriber terminating units includes an error count counting portion counting an error count in a predetermined time range based on the number of corrections by an error correction function, and an error count transmitting portion transmitting the error count to the office terminating unit. The office terminating unit includes an error count receiving portion receiving the error count from each of the subscriber terminating units as a received error count, a correction method determining portion determining, based on the received error count, an error correction method or an error correction disuse which is used in each of the subscriber terminating units as a determined error correction method or a determined error correction disuse, and a correction method transmitting portion transmitting the determined error correction method or the determined error correction disuse to each of the subscriber terminating units.

A fifth exemplary embodiment of the invention is a subscriber terminating unit enable to communicate with an office terminating unit through an optical transmission path. The subscriber terminating unit includes an error count counting portion counting an error count in a predetermined time range based on the number of corrections by an error correction function, and an error count transmitting portion transmitting the error count to the office terminating unit.

A sixth exemplary embodiment of the invention is an office terminating unit enable to communicate with a plurality of subscriber terminating units through an optical transmission path. The office terminating unit includes an error count receiving portion receiving, from each of the subscriber terminating units, an error count in a predetermined time range based on the number of corrections by an error correction function to produce a received error count, a correction method determining portion determining, based on the received error count, an error correction method or an error correction disuse which is used in each of the subscriber terminating units to produce a determined error correction method or a determined error correction disuse, and a correction method transmitting portion transmitting the determined error correction method or the determined error correction disuse to each of the subscriber terminating units.

A seventh exemplary embodiment of the invention is a recording medium storing a program executed in a computer of a subscriber terminating unit enable to communicate with an office terminating unit through an optical transmission path. The program makes the computer execute an error count counting process counting an error count in a predetermined time range based on the number of corrections by an error correction function, and an error count transmitting process transmitting the error count to the office terminating unit.

An eighth exemplary embodiment of the invention is a recording medium storing a program executed in a computer of an office terminating unit enable to communicate with a plurality of subscriber terminating units through an optical transmission path. The program makes the computer execute an error count receiving process receiving, from each of the subscriber terminating units, an error count in a predetermined time range based on the number of corrections by an error correction function to produce a received error count, a correction method determining process determining, based on the received error count, an error correction method or an error correction disuse which is used in each of the subscriber terminating units to produce a determined error correction method or a determined error correction disuse, and a correction method transmitting process transmitting the determined error correction method or the determined error correction disuse to each of the subscriber terminating units.

A first exemplary advantage according to the invention is that a special-purpose evaluation signal is not required. A second exemplary advantage according to the invention is that it is possible to effectively make full use of a band by optimizing the error correction method based on a measured value of an error count in a predetermined time range on the basis of the number of corrections by an error correction function.

While the invention has been particularly shown and described with reference to exemplary embodiments thereof, the invention is not limited to these embodiments. It will be understood by those of ordinary skill in the art that various changes in form and details may be made therein without departing from the spirit an scope of the present invention as defined by the claims. For example, although the description is made as regards in a case where any of RS(255, 239), RS(255, 223), and the error correction disuse can be selected as the error correction method in the above-mentioned exemplary embodiments, the error correction method is not limited to them and the present invention may be applicable in a similar manner to a case of an automatic discrimination using other error correction methods.

What is claimed is:

1. A communications method for an optical communications system comprising an office terminating unit and a plurality of subscriber terminating units each of which is connected to said office terminating unit via an optical transmission path, said communications method comprising:
counting, in each of said plurality of subscriber terminating units, an error count in a predetermined time range based on the number of corrections by an error correction function;
transmitting the error count from each of said plurality of subscriber terminating units to said office terminating unit;
receiving, in said office terminating unit, the error count as a received error count; and
determining, in said office terminal unit, based on the received error count, an error correction method or an error correction disuse which is used in each of said plurality of subscriber terminating units as a determined error correction method or a determined error correction disuse.

2. The communications method as claimed in claim 1, wherein the predetermined time range is a range between a starting time instant of a MPCP (Multipoint Control Protocol) sequence and a completed time instant at which a logical link is established, the predetermined time range including a date frame portion and an IDLE portion.

3. The communications method as claimed in claim 2, wherein said transmitting transmits the error count to said office terminating unit when the logic link is established in the MPCP sequence.

4. The communications method as claimed in claim 1, wherein said transmitting transmits the error count to said office terminating unit using an OAM (Operation, Administration, and Maintenance) signal.

5. The communications method as claimed in claim 1, wherein further comprising:
transmitting the determined error correction method or the determined error correction disuse from said office terminating unit to each of said plurality of subscriber terminating units;
receiving, in each of said plurality of subscriber terminating units, the determined error correction method or the determined error correction disuse as a received error correction method or a received error correction disuse;
carrying out, in each of said plurality of subscriber terminating units, communications using the received error correction method; and
carrying out, in said office terminating unit, communications using the determined error correction method after transmitting the determined error correction method or the determined error correction disuse.

6. An optical communications system comprising:
an office terminating unit;
a plurality of subscriber terminating units; and
an optical transmission path communicatively connecting said office terminating unit with said plurality of subscriber terminating units,
wherein each of said subscriber terminating units comprises:
an error count counting portion counting an error count in a predetermined time range based on the number of corrections by an error correction function; and
an error count transmitting portion transmitting the error count to said office terminating unit,
wherein said office terminating unit comprises:
an error count receiving portion receiving the error count from each of said subscriber terminating units as a received error count;
a correction method determining portion determining, based on the received error count, an error correction method or an error correction disuse which is used in each of said subscriber terminating units as a determined error correction method or a determined error correction disuse; and
a correction method transmitting portion transmitting the determined error correction method or the determined error correction disuse to each of said subscriber terminating units.

7. The optical communications system as claimed in claim 6, wherein said predetermined time range is a range between a starting time instant of a MPCP (Multipoint Control Protocol) sequence and a completed time instant at which a logical link is established, said predetermined time range including a data frame portion and an IDLE portion.

8. The optical communications system as claimed in claim 7, wherein said error count transmitting portion transmits the error count to said office terminating unit when the logical link is established in the MPCP sequence, and
wherein said correction method transmitting portion transmits the determined error correction method or the determined error correction disuse to each of said subscriber terminating units when the logical link is established in the MPCP sequence.

9. The optical communications system as claimed in claim 6, wherein said error count transmitting portion transmits the error count to said office terminating unit using an OAM (Operations, Administration, and Maintenance) signal, and
wherein said correction method transmitting portion transmits the determined error correction method or the determined error correction disuse to each of said subscriber terminating units using the OAM signal.

10. The optical communications system as claimed in claim 6, wherein said office terminating unit further comprises an office correction method switching portion carrying out communications using the determined error correction method, and
wherein each of said subscriber terminating units further comprises:
a correction method receiving portion receiving the determined error correction method or the determined error correction disuse from said office terminating unit as a received error correction method or a received error correction disuse; and
a subscriber correction method switching portion carrying out communications using the received error correction method.

11. A subscriber terminating unit enable to communicate with an office terminating unit through an optical transmission path, said subscriber terminating unit comprising:
an error count counting portion counting an error count in a predetermined time range based on the number of corrections by an error correction function; and
an error count transmitting portion transmitting the error count to said office terminating unit.

12. The subscriber terminating unit as claimed in claim 11, wherein said predetermined time range is a range between a starting time instant of a MPCP (Multipoint Control Protocol) sequence and a completed time instant at which a logical link is established, said predetermined time range including a data frame portion and an IDLE portion.

13. The subscriber terminating unit as claimed in claim 12, wherein said error count transmitting portion transmits the error count to said office terminating unit when the logical link is established in the MPCP sequence.

14. The subscriber terminating unit as claimed in claim 11, wherein said error count transmitting portion transmits the error count to said office terminating unit using an OAM (Operations, Administration, and Maintenance ) signal.

15. The subscriber terminating unit as claimed in claim 11, wherein further comprises:
a correction method receiving portion receiving a determined error correction method or a determined error correction disuse from said office terminating unit as a received error correction method or a received error correction disuse; and
a correction method switching portion carrying out communications using the received error correction method.

16. An office terminating unit enable to communicate with a plurality of subscriber terminating units through an optical transmission path, said office terminating unit comprising:
an error count receiving portion receiving, from each of said subscriber terminating units, an error count in a predetermined time range based on the number of corrections by an error correction function, said error count receiving portion producing a received error count;
a correction method determining portion determining, based on the received error count, an error correction method or an error correction disuse which is used in each of said subscriber terminating units, said correction method determining portion producing a determined error correction method or a determined error correction disuse; and
a correction method transmitting portion transmitting the determined error correction method or the determined error correction disuse to each of said subscriber terminating units.

17. The office terminating unit as claimed in claim 16, wherein said predetermined time range is a range between a starting time instant of a MPCP (Multipoint Control Protocol) sequence and a completed time instant at which a logical link is established, said predetermined time range including a data frame portion and an IDLE portion.

18. The office terminating unit as claimed in claim 17, wherein said correction method transmitting portion transmits the determined error correction method or the determined error correction disuse to each of said subscriber terminating units when the logical link is established in the MPCP sequence.

19. The office terminating unit as claimed in claim 16, wherein said correction method transmitting portion transmits the determined error correction method or the determined error correction disuse to each of said subscriber terminating units using an OAM (Operations, Administration, and Maintenance) signal.

20. The office terminating unit as claimed in claim 16, wherein further comprises a correction method switching portion carrying out communications using the determined error correction method.

21. A recording medium storing a program executed in a computer of a subscriber terminating unit enable to communicate with an office terminating unit through an optical transmission path, said program making said computer execute:
an error count counting process counting an error count in a predetermined time range based on the number of corrections by an error correction function; and
an error count transmitting process transmitting the error count to said office terminating unit.

22. The recording medium as claimed in claim 21, wherein said predetermined time range is a range between a starting time instant of a MPCP (Multipoint Control Protocol) sequence and a completed time instant at which a logical link is established, said predetermined time range including a data frame portion and an IDLE portion.

23. The recording medium as claimed in claim 22, wherein said error count transmitting process transmits the error count to said office terminating unit when the logical link is established in the MPCP sequence.

24. The recording medium as claimed in claim 21, wherein said error count transmitting process transmits the error count to said office terminating unit using an OAM (Operations, Administration, and Maintenance) signal.

25. The recoding medium as claimed in claim 21, wherein said program further makes said computer execute:
a correction method receiving process receiving a determined error correction method or a determined error correction disuse from said office terminating unit as a received error correction method or a received error correction disuse; and
a correction method switching process carrying out communications using the received error correction method.

26. A recording medium storing a program executed in a computer of an office terminating unit enable to communicate with a plurality of subscriber terminating units through an optical transmission path, said program making said computer execute:
an error count receiving process receiving, from each of said subscriber terminating units, an error count in a predetermined time range based on the number of corrections by an error correction function, said error count receiving process producing a received error count;
a correction method determining process determining, based on the received error count, an error correction method or an error correction disuse which is used in each of said subscriber terminating units, said correction method determining process producing a determined error correction method or a determined error correction disuse; and
a correction method transmitting process transmitting the determined error correction method or the determined error correction disuse to each of said subscriber terminating units.

27. The recording medium as claimed in claim 26, wherein said predetermined time range is a range between a starting time instant of a MPCP (Multipoint Control Protocol) sequence and a completed time instant at which a logical link is established, said predetermined time range including a data frame portion and an IDLE portion.

28. The recording medium as claimed in claim 27, wherein said correction method transmitting process transmits the determined error correction method or the determined error correction disuse to each of said subscriber terminating units when the logical link is established in the MPCP sequence.

29. The recording medium as claimed in claim 26, wherein said correction method transmitting process transmits the determined error correction method or the determined error correction disuse to each of said subscriber terminating units using an OAM (Operations, Administration, and Maintenance) signal.

30. The recording medium as claimed in claim 26, wherein said program makes said computer further execute a correction method switching process carrying out communications using the determined error correction method.
